(19) United States
(12) Patent Application Publication
(10) Pub. No.: US 2013/0018217 A1
(43) Pub. Date: Jan. 17, 2013

(54) Clover Shape Attachment for Implantable Floating Mass Transducer

(71) Applicants: Michael Santek, Innsbruck (AT); Markus Hütter, Igls (AT)

(72) Inventors: Michael Santek, Innsbruck (AT); Markus Hütter, Igls (AT)

(73) Assignee: Vibrant Med-Ei Hearing Technology GmbH, Innsbruck (AT)

(21) Appl. No.: 13/546,254

(22) Filed: Jul. 11, 2012

Related U.S. Application Data
(60) Provisional application No. 61/506,286, filed on Jul. 11, 2011.

(51) Int. Cl. H04R 25/00

(52) U.S. Cl. 600/25

(57) ABSTRACT

A middle ear prosthesis device includes an elongated prosthesis member having first and second ends. A transducer clamp is at the first end with clamping fingers for securely engaging the outer surface of an enclosed mechanical signal transducer. An ossicle fastener is at the second end for secure attachment to the ossicle of the middle ear. The ossicle fastener includes parallel planar fastener clips each having a clover shape with springy lobes surrounding an interior region defined by lobe connecting bends. There is an opening between opposing bent leg ends of each fastener clip that displaceably provides access for the ossicle to the interior region of the clip so that the fastener clips securely enclose an ossicle such as the incus bone within the interior region. Vibration of the mechanical signal transducer is coupled by the prosthesis member to the incus secured within the ossicle fastener.

This supplication claims priority from U.S. Provisional Patent Application 61/506,286, filed Jul. 11, 2011, which incorporated herein by reference.

### TECHNICAL FIELD

The present invention relates to medical implants, and more specifically to a novel clover shape attachment for securing an implantable floating mass transducer to the incus bone in the middle ear of a patient.

### BACKGROUND ART

A normal ear transmits sounds as shown in FIG. 1 through the outer ear 101 to the tympanic membrane (eardrum) 102, which moves the ossicles of the middle ear 103 (malleus, incus, and stapes) that vibrate the oval window and round window openings of the cochlea 104. The cochlea 104 is a long narrow organ wound spirally about its axis for approximately two and a half turns. It includes an upper channel known as the scala vestibuli and a lower channel known as the scala tympani, which are connected by the cochlear duct. The cochlea 104 forms an upright spiraling cone with a center called the modiolar where the spiral ganglion cells of the acoustic nerve 113 reside. In response to received sounds transmitted by the middle ear 103, the fluid-filled cochlea 104 functions as a transducer to generate electric pulses which are transmitted to the cochlear nerve 113, and ultimately to the brain.

Hearing is impaired when there are problems in the ear's ability to transduce external sounds into meaningful action potentials along the neural substrate of the cochlea 104. To improve impaired hearing, various types of hearing prostheses have been developed. For example, when a hearing impairment is related to the operation of the middle ear 103, a conventional hearing aid or a middle ear implant (MEI) device may be used to provide acoustic-mechanical vibration to the auditory system.

FIG. 1 also shows some components in a typical MEI arrangement where an external audio processor 111 processes ambient sounds to produce an implant communications signal that is transmitted through the skin to an implanted receiver 108. Receiver 108 includes a receiver coil that transcutaneously receives signals the implant communications signal which is then demodulated into a transducer stimulation signals which is sent over leads 109 through a surgically created channel in the temporal bone to a floating mass transducer (FMT) 110 secured to the incus bone in the middle ear 103. The transducer stimulation signals cause drive coils within the FMT 110 to generate varying magnetic fields which in turn vibrate a magnetic mass suspended within the FMT 110. The vibration of the inertial mass of the magnet within the FMT 110 creates vibration of the housing of the FMT 110 relative to the magnet. This vibration of the FMT 110 is coupled to the incus in the middle ear 103 and then to the cochlea 104 and is perceived by the user as sound. See U.S. Pat. No. 6,190,305, which is incorporated herein by reference.

Middle ear implants using electromagnetic transducers such as FMT 110 can present some problems. Many are installed using complex surgical procedures which present the usual risks associated with major surgery and which also require disarticulating (disconnecting) one or more of the bones of the middle ear 103. Disarticulation deprives the patient of any residual hearing he or she may have had prior to surgery, placing the patient in a worsened position if the implanted device is later found to be ineffective in improving the patient's hearing. Moreover, fixation of the FMT 110 onto the incus is difficult in many cases with normal middle ear anatomy. Among other things, the incus has a round shape at the tip of the long process and is more oval towards the main body. This makes it difficult to crimp a clip of the FMT 110 onto the narrow facial recess and the variations in the incus anatomy. In addition, blood vessels within the incus need to be preserved to avoid necrosis of the incus.

U.S. Pat. No. 6,579,317 describes a prosthesis device which uses clamping fingers that enclose one end of the incus. The device is inserted into the middle ear by a transcanal surgical procedure, and the arrangement described is not designed for implantation through a posterior tympanotomy.

U.S. patent application Ser. No. 13/009,104, filed Jan. 19, 2011 (incorporated herein by reference) describes a partial ossicular replacement prosthesis (PORP) device that uses a locking clamp having a clamp strap to connect a prosthesis member to an ossicle so as to couple vibration from the ossicle to the outer cochlea surface of a recipient patient and thereby providing sound sensation to the patient.

### SUMMARY

Embodiments of the present invention are directed to a middle ear prosthesis device which includes an elongated prosthesis member having first and second ends. A transducer clamp is at the first end of the prosthesis member with clamping fingers for securely engaging the outer surface of an enclosed mechanical signal transducer. An ossicle fastener is at the second end of the prosthesis member and is adapted for secure attachment to the ossicle of a patient middle ear. The ossicle fastener includes parallel planar fastener clips each having a clover shape with springy lobes surrounding an interior region defined by lobe connecting bends. There is an opening between opposing bent leg ends of each fastener clip that displaceably provides access for the ossicle to the interior region of the clip, so that the fastener clips securely enclose the ossicle within the interior region. Vibration of the mechanical signal transducer is coupled by the prosthesis member to the incus secured within the ossicle fastener.

The ossicle may specifically be the incus bone and the mechanical signal transducer may specifically be a floating mass transducer. In specific embodiments, the fastener clips may be made of a titanium alloy material or a superelastic nitinol material.

### BRIEF DESCRIPTION OF THE DRAWINGS

FIG. 1 shows various anatomical structures in a human ear containing a middle ear implant device.

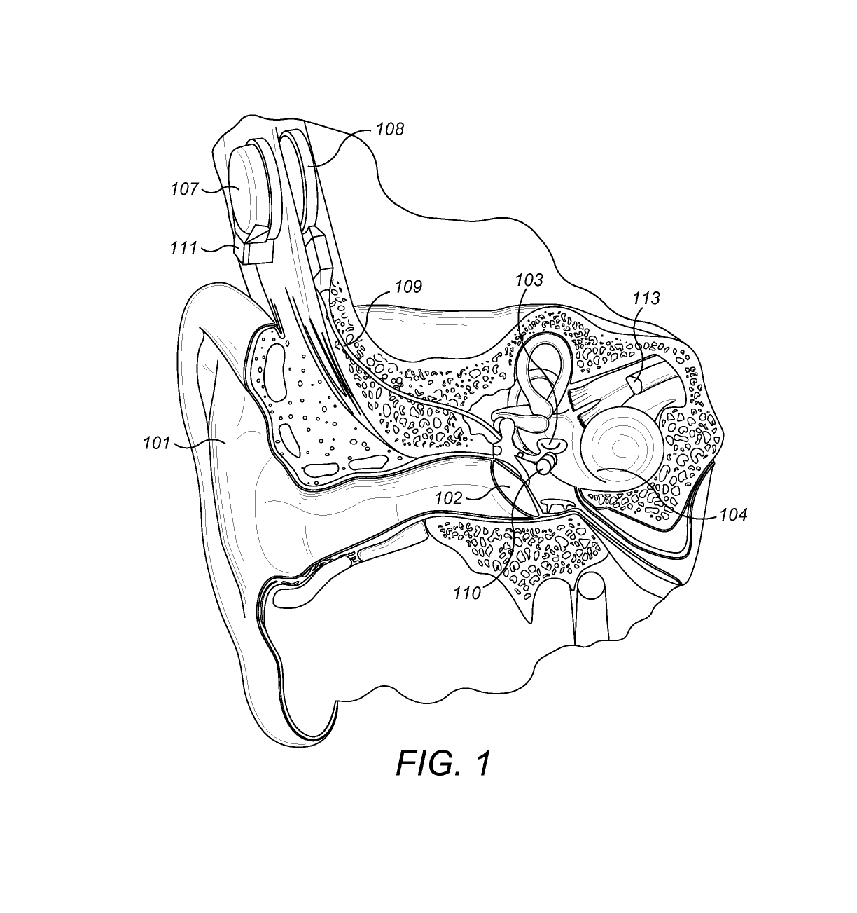

FIG. 2 shows an example of a middle ear prosthesis device according to an embodiment of the present invention.

### DETAILED DESCRIPTION

Various embodiments of the present invention are directed to an improved self-crimping ossicular prosthesis device to connect a mechanical transducer to an ossicle of a recipient patient, thereby providing sound sensation to the patient.

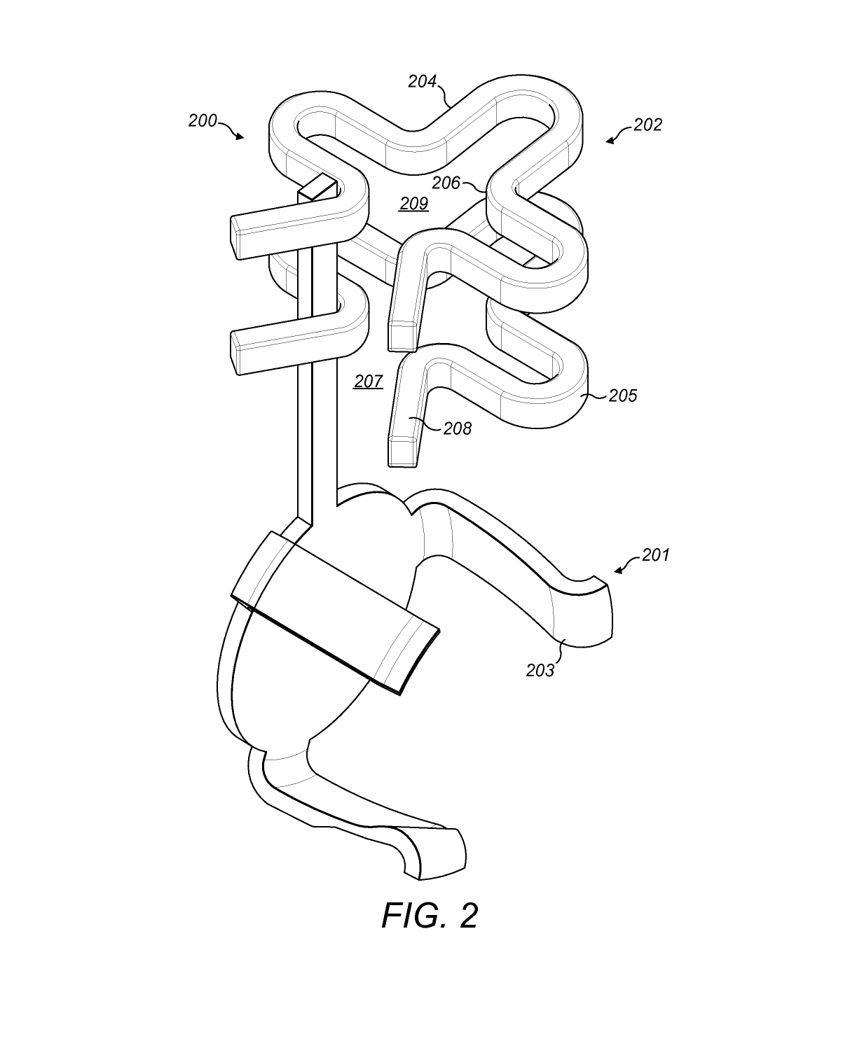

FIG. 2 shows an example of a middle ear prosthesis device 200 according to an embodiment of the present invention. An elongated prosthesis member 207 connects a transducer clamp 201 at one end and an ossicle fastener 202 at the other end so as to couple mechanical vibrations from a transducer enclosed within the transducer clamp 201 to an ossicle such as the incus bone securely enclosed within the ossicle fastener 202. The transducer clamp 201 includes multiple clamping fingers 203 for securely engaging the outer surface of an enclosed mechanical signal transducer such as a floating mass transducer. The ossicle fastener 202 includes parallel planar fastener clips 204 each having a clover shape with springy lobes 205 surrounding an interior region 209 defined by lobe connecting bends 206. There is an opening 207 between opposing bent leg ends 208 of each fastener clip 204 that displaceably provides access for the ossicle to the interior region 209 of the clip. This arrangement allows the fastener clips 204 to securely enclose the long process of the incus within the interior region 209.

The fastener clips 204 are flexible and self-crimping by use of the above arrangement and use of an appropriate material such as a titanium alloy or a superelastic nitinol material. The clover shape lobes 205 of the fastener clips 204 provide crimping tension and flexibility for using the device 200 across a broad range of anatomical dimensions and variations. Moreover, the pair of fastener clips 204 provides twin four point fixation to the incus with enhanced stability and less stress to the incus. And the design of the fastener clips 204 also respects the anatomical variations and avoids strangulating of blood vessels that might cause necrosis.

The prosthesis device 200 can be surgically installed via a conventional facial recess approach through a very narrow posterior tympanotomy (a drilled hole between the facial nerve and the corda tympany, which is responsible for taste) as described, for example, by Wen Yang Su et al., “Anatomical Measurements Of The Cochlear Aqueduct, Round Window Membrane, Round Window Niche, And Facial Recess,” Laryngoscope 1982, 82:483-486; incorporated herein by reference. In addition, the geometry of the fastener clips 204 may be generically non-lateral so that there is no need for individual left- and right-side devices. All this allows for a faster and safer surgical installation procedure.

Although various exemplary embodiments of the invention have been disclosed, it should be apparent to those skilled in the art that various changes and modifications can be made which will achieve some of the advantages of the invention without departing from the true scope of the invention.

What is claimed is:

1. A middle ear prosthesis device comprising:
an elongated prosthesis member having first and second ends;
a transducer clamp at the first end of the prosthesis member including a plurality of clamping fingers adapted for securely engagement to an outer surface of an enclosed mechanical signal transducer; and
an ossicle fastener at the second end of the prosthesis member adapted for secure attachment to an ossicle of a patient middle ear and including a plurality of parallel planar fastener clips, each clip having an clover shape with:
i. a plurality of springy lobes surrounding an interior region defined by lobe connecting bends, and
ii. an opening between opposing bent leg ends displaceably providing access for the ossicle to the interior region,
so that the fastener clips securely enclose the ossicle within the interior region;
whereby vibration of the mechanical signal transducer is coupled by the prosthesis member to the incus secured within the ossicle fastener.

2. A middle ear prosthesis according to claim 1, wherein the ossicle is the incus bone.

3. A middle ear prosthesis according to claim 1, wherein the mechanical signal transducer is a floating mass transducer.

4. A middle ear prosthesis according to claim 1, wherein the fastener clips are made of a titanium alloy material.

5. A middle ear prosthesis according to claim 1, wherein the fastener clips are made of a superelastic nitinol material.
